(19) United States
(12) Patent Application Publication
(10) Pub. No.: US 2024/0379300 A1
(43) Pub. Date: Nov. 14, 2024

(54) HIGH-VOLTAGE DIRECT CURRENT (DC) RELAY CAPABLE OF ENHANCING ARC EXTINGUISHING CAPABILITY

(71) Applicant: Xiamen Hongfa Electric Power Controls Co., Ltd., Xiamen, Fujian (CN)

(72) Inventors: Wenguang DAI, Xiamen, Fujian (CN); Liji SU, Xiamen, Fujian (CN); Fengzhu XIE, Xiamen, Fujian (CN)

(21) Appl. No.: 18/690,606

(22) PCT Filed: Sep. 2, 2022
(86) PCT No.: PCT/CN2022/116780

§ 371 Date: Mar. 8, 2024

(30) Foreign Application Priority Data
Sep. 10, 2021 (CN) 202122196800.3

(51) Int. Cl. H01H 9/44; H01H 1/06; H01H 1/20

(52) U.S. Cl. CPC H01H 9/443; H01H 1/06; H01H 1/20

(57) ABSTRACT

A high-voltage DC relay for enhancing arc extinguishing capability includes two static contact leading-out terminals; a movable contact piece arranged under the two static contact leading-out terminals; two first permanent magnets respectively arranged at outer side of two ends of the movable contact piece in a length direction; two second permanent magnets respectively arranged on the movable contact piece between the two static contact leading-out terminals at positions where the movable contacts are in contact with the static contacts, and sides having polarity of the second permanent magnets facing the corresponding first permanent magnets, and polarities of the sides having polarity of the second permanent magnets is opposite to polarities of the sides of the first permanent magnets facing the positions where the movable contacts are in contact with the static contacts.

### CROSS-REFERENCE

This application is a national stage of International PCT Application No. PCT/CN2022/116780, filed on Sep. 2, 2022, which claims priority to Chinese Application No. 202122196800.3, filed on Sep. 10, 2021, which is incorporated herein by reference in its entirety.

### TECHNICAL FIELD

The present disclosure relates to the technical field of relays, in particular to a high-voltage DC relay for enhancing arc extinguishing capability.

### BACKGROUND

A high-voltage DC relay is a relay with a capability to handle high power. Under harsh conditions such as high voltage and large current, it still has characteristics of incomparable reliability and long service life in comparison with the conventional relay, and thus is widely used in various fields, such as new energy vehicles. In the prior art, a high-voltage DC relay adopts a movable contact piece direct-acting structure, in which a contact part is formed by two static contacts and one movable contact piece. The two static contacts are mounted on a top of a ceramic cover (or shell), and bottom ends of the two static contacts (i.e., static contact leading-out terminals) extend into the ceramic cover, and the movable contact piece is distributed in the ceramic cover in a direct-acting manner, and the two ends of the movable contact piece used as movable contacts are respectively matched with the bottom ends of two static contacts used as static contacts. When the movable contacts of the two ends of the movable contact piece are respectively in contact with the static contacts on the bottom ends of the two static contact leading-out terminals, a current flows in through one of the static contacts and flows out of the other static contact through the movable contact piece; the movable contact piece is mounted to one end of the pushing rod, and the other end of the pushing rod is connected with a movable core of the magnetic circuit portion. When a coil is connected with current to make the pushing rod move upwards, the two ends of the movable contact piece are respectively in contact with the two static contacts so as to connect a load. When the coil is disconnected with the current, the pushing rod moves downwards under the action of a return spring, and the two ends of the movable contact piece are separated from the two static contacts so as to cut off the load. In the prior art, this high-voltage DC relay usually adopts permanent magnets to extinguish arc. The typical configuration of the permanent magnets is that permanent magnets are respectively arranged at outer side of two ends of the movable contact piece in a length direction, and the two permanent magnets are used to achieve arc extinction. In the existing solution of the arc extinction by using such two permanent magnets, although it has a good arc blowing direction and meets non-polarity need, the magnetic field intensity is weak, especially at an arc starting point (i.e., at a center of the leading-out terminal), the magnetic induction intensity near the leading-out terminal is gradually weakened, for large-load products, the ceramic cavity is larger, so that the magnetic field intensity of the arc extinguishing portion to the arc starting point is less, and the arc extinguishing effect is poor, resulting in hardly meet the requirements of new energy vehicles and energy storage projects for improving a system load.

### SUMMARY

A high-voltage DC relay for enhancing arc extinguishing capability includes two static contact leading-out terminals; a movable contact piece arranged under the two static contact leading-out terminals, and two ends of the movable contact piece used as movable contacts being respectively matched with bottom ends of the two static contact leading-out terminals used as static contacts; two first permanent magnets respectively arranged at outer side of two ends of the movable contact piece in a length direction, corresponding to a position where the movable contacts are in contact with the static contacts, and sides having polarity of the two first permanent magnets respectively facing corresponding positions where the movable contacts are in contact with the static contacts; two second permanent magnets respectively arranged on the movable contact piece between the two static contact leading-out terminals at positions where the movable contacts are in contact with the static contacts, and sides having polarity of the second permanent magnets facing the corresponding first permanent magnets, and polarities of the sides having polarity of the second permanent magnets is opposite to polarities of the sides of the first permanent magnets facing the positions where the movable contacts are in contact with the static contacts.

According to an embodiment of present disclosure, magnetic pole surfaces of the second permanent magnets are smaller than magnetic pole surfaces of the first permanent magnets.

According to an embodiment of present disclosure, the movable contact piece is in a middle portion of each of the first permanent magnets in a height direction.

According to an embodiment of present disclosure, the two second permanent magnets are symmetrically arranged on two sides of a center line of the movable contact piece in a length direction.

According to an embodiment of present disclosure, the second permanent magnets are stuck and fixed on an upper surface or a lower surface of the movable contact piece.

According to an embodiment of present disclosure, grooves recessed downward are formed on an upper surface of the movable contact piece, or grooves recessed upward are formed on a lower surface of the movable contact piece, and at least a portion of the second permanent magnets are embedded into the grooves.

According to an embodiment of present disclosure, the two second permanent magnets are two separate parts, and there is a preset space between the two second permanent magnets.

According to an embodiment of present disclosure, the two second permanent magnets are connected into one piece.

According to an embodiment of present disclosure, the high-voltage DC relay further includes two first U-shaped yokes respectively arranged on the two first permanent magnets, a bottom wall of each first U-shaped yoke is contacted with one side of the corresponding first permanent magnet facing away from the corresponding movable contact, and two side walls of each first U-shaped yoke are respectively arranged on two sides of the movable contact piece in a width direction and are opposite to the corresponding movable contact.

According to an embodiment of present disclosure, an anti-short circuit structure is provided in a middle portion of the movable contact piece in a length direction; the anti-short circuit structure is arranged in the preset space between two second permanent magnets.

According to an embodiment of present disclosure, the anti-short circuit structure is an anti-short circuit ring.

According to an embodiment of present disclosure, the anti-short circuit ring is formed by matching two linear shape upper armatures and two U-shaped lower armatures; a through hole penetrating through a thickness of the movable contact piece is arranged in the middle portion of the movable contact piece in the length direction; the two upper armatures are fixed on a top portion of a U-shaped bracket of a pushing rod of the high-voltage DC relay, the two U-shaped lower armatures are respectively fixed to the movable contact piece, and side walls of the two U-shaped lower armatures pass through the through hole of the movable contact piece, top ends of the two U-shaped lower armatures are exposed out of an upper surface of the movable contact piece and correspondingly matched with the two linear shape upper armatures; a circular magnetic field generated by the movable contact piece being energized forms a closed magnetic circuit within an annular component formed by the linear shape upper armature and the U-shaped lower armature.

The present disclosure will be further described in detail with the attached drawings and examples; however, the high-voltage DC relay for enhancing arc extinguishing capability is not limited to the embodiments.

### BRIEF DESCRIPTION OF THE DRAWINGS

The above-described and other features and advantages of the present disclosure will become more apparent from the detailed descriptions of exemplary embodiments with reference with the accompanying drawings.

FIG. 1 is a perspective view of a partial configuration according to a first embodiment of a high-voltage DC relay for enhancing arc extinguishing capability of the present disclosure;

FIG. 2 is a front view of FIG. 1;

FIG. 3 is a top view of FIG. 1;

FIG. 4 is a sectional view taken along line A-A in FIG. 3;

FIG. 5 is a perspective view of a partial configuration according to a second embodiment of the high-voltage DC relay for enhancing the arc extinguishing capability of the present disclosure;

FIG. 6 is a front view of FIG. 5;

FIG. 7 is a top view of FIG. 5;

FIG. 8 is a sectional view taken along line B-B in FIG. 6;

FIG. 9 is a sectional view taken along the line C-C in FIG. 7;

FIG. 10 is a schematic view of interaction between a permanent magnet and a short-circuit ring in the second embodiment of the present disclosure.

### DETAILED DESCRIPTION

Now, the exemplary implementations will be described more completely with reference to the accompanying drawings. However, the exemplary implementations can be implemented in various forms and should not be construed as limiting the implementations as set forth herein. Although terms having opposite meanings such as “up” and “down” are used herein to describe the relationship of one component relative to another component, such terms are used herein only for the sake of convenience, for example, “in the direction illustrated in the figure”. It can be understood that if a device denoted in the drawings is turned upside down, a component described as “above” something will become a component described as “under” something. When a structure is described as “above” another structure, it probably means that the structure is integrally formed on another structure, or, the structure is “directly” disposed on another structure, or the structure is “indirectly” disposed on another structure through an additional structure.

### The First Embodiment

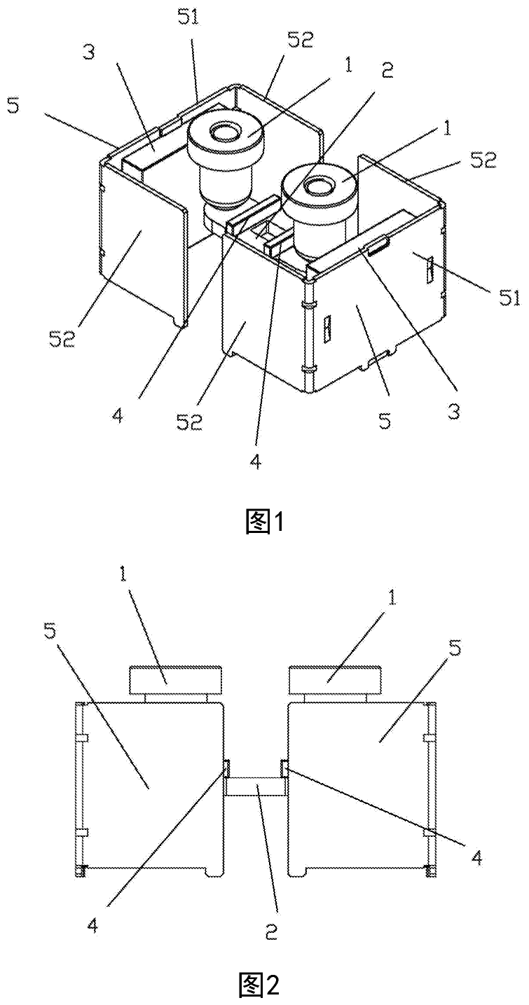

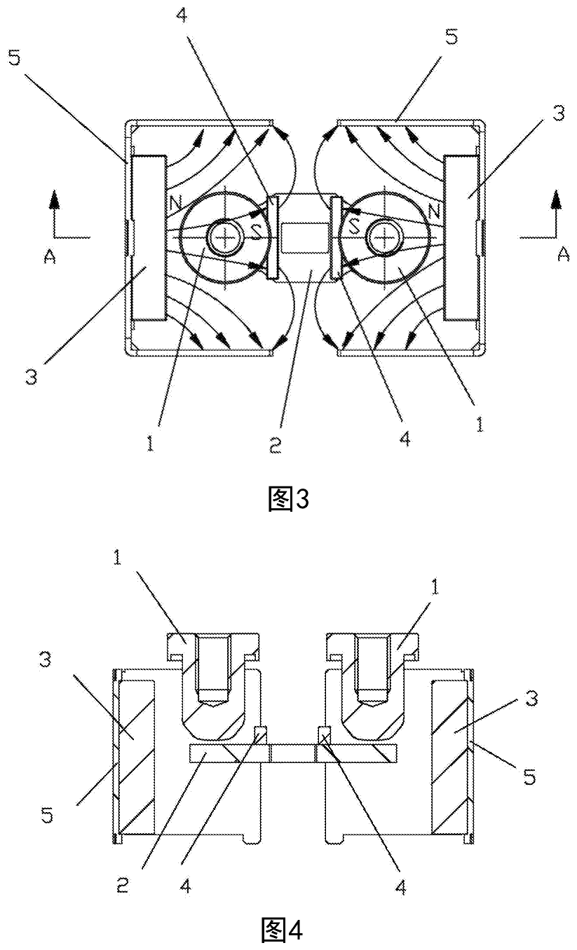

Referring to FIG. 1 to FIG. 4, a high-voltage DC relay for enhancing arc extinguishing capability of the present disclosure includes two static contact leading-out terminals 1 and one movable contact piece 2. The movable contact piece 2 is arranged under the two static contact leading-out terminals 1, and two ends of the movable contact piece 2 used as movable contacts are respectively matched with bottom ends of the two static contact leading-out terminals I used as static contacts. First permanent magnets 3 are respectively arranged at outer side of two ends of the movable contact piece 2 in a longitudinal direction, corresponding to a position where the movable contacts are in contact with the static contacts, and sides having polarity of the two first permanent magnets 3 face the corresponding movable contacts respectively. Second permanent magnets 4 are respectively arranged at positions where the movable contacts are in contact with the static contacts, between the two static contact leading-out terminals 1, on the movable contact piece 2. The side having polarity of the second permanent magnet 4 faces the side having polarity of the corresponding first permanent magnet 3, and polarity of the side of the second permanent magnet 4 facing the movable contacts is opposite to polarity of the side of the first permanent magnet 3 facing the movable contacts.

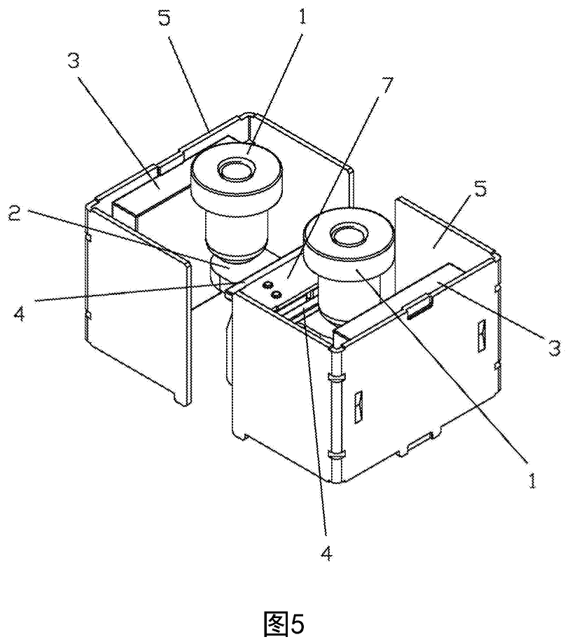

In this embodiment, as shown in FIG. 3 and FIG. 4, a magnetic polarity of the side (i.e., a right face) of the first permanent magnet 3 facing the movable contacts corresponding to one end (left end) of the movable contact piece 2 is a N pole, and a magnetic polarity of the side (i.e., a left face) of the first permanent magnet 3 facing the contacts corresponding to the other end (right end) of the movable contact piece 2 is also a N pole. A side having polarity (i.e., a left face) of the second permanent magnet 4 corresponding to one end (left end) of the movable contact piece 2 faces a side having polarity (i.e., a right side) of the corresponding first permanent magnet 3, the polarity of the left face of the second permanent magnet 4 is opposite to the polarity of the right face of the first permanent magnet 3, and the magnetic polarity of the left face of the second permanent magnet 4 at the left end of the movable contact piece 2 is a S pole; similarly, the magnetic polarity of the right face of the second permanent magnet 4 corresponding to the other end (right end) of the movable contact piece 2 is a S pole. For the left end of the movable contact piece 2, magnetic field lines of the first permanent magnet 3 radiate to the right, since the S pole of the second permanent magnet 4 is at the right side of the static contact leading-out terminals 1 on the left side, the magnetic field lines of the first permanent magnet 3 gather at a center of the static contact leading-out terminals 1 on the left side, which can enhance the magnetic field intensity of the first permanent magnet 3 at the position where the movable contacts are in contact with the static contacts, especially at the center of the leading-out terminals (i.e. the arc starting point), and accelerate the arc extinguishing speed by magnetic blowing at the moment of starting the arc. Similarly, For the right end of the movable contact piece 2, the magnetic field lines of the first permanent magnet 3 radiate to the left, since the S pole of the second permanent magnet 4 is at the left side of the static contact leading-out terminals 1 on the right side, the magnetic field lines of the first permanent magnet 3 gather at a center of the static contact leading-out terminals 1 on the right side.

In this embodiment, the magnetic pole surface of the second permanent magnet 4 is smaller than the magnetic pole surface of the first permanent magnet 3, that is, the first permanent magnet 3 is a large permanent magnet and the second permanent magnet 4 is a small permanent magnet.

In this embodiment, the movable contact piece 2 corresponds to a middle portion of the first permanent magnet 3 in a height direction.

In this embodiment, the two second permanent magnets 4 are symmetrically arranged on two sides of a center line of the movable contact piece 2 in a length direction W.

In this embodiment, the second permanent magnet 4 is stuck and fixed above the movable contact piece 2, of course, also be above the movable contact piece, a groove recessed downwardly is arranged at a position corresponding to the second permanent magnet, and a portion of the bottom of the second permanent magnet is embedded into the groove. In addition, the second permanent magnet 4 may be stuck and fixed under the movable contact piece 2, or under the movable contact piece, a groove recessed upwardly is arranged at a position corresponding to the second permanent magnet, and a portion of the top of the second permanent magnet is embedded into the groove.

In this embodiment, the two second permanent magnets 4 are two separate parts, and there is a preset space between the two second permanent magnets 4.

In this embodiment, the high-voltage DC relay further includes two first U-shaped yokes 5 respectively arranged on two first permanent magnets 3, wherein the bottom walls 51 of the two first U-shaped yokes 5 are respectively in contact with one side of the corresponding first permanent magnet 3 facing away from the corresponding movable contacts (the S pole of the first permanent magnet 3 in this embodiment), and the two side walls 52 of the two first U-shaped yokes 5 are respectively arranged on two sides of the movable contact piece 2 in a width direction, and are opposite to the corresponding movable contacts.

In the high-voltage DC relay for enhancing arc extinguishing capability of the present disclosure, on the movable contact piece 2, a second permanent magnet 4 is arranged at a position where the movable contacts are in contact with the static contacts, between the two static contact leading-out terminals, and a side having polarity of the second permanent magnet 4 faces a side having polarity of the corresponding first permanent magnet, and polarity of which is opposite to the polarity of a side of the first permanent magnet 3 facing the movable contacts. According to the structure of the present disclosure, due to the specific position where the second permanent magnet 4 is position, magnetic field intensity of a horizontal magnetic field of the first permanent magnet 3 at a position where the movable contacts are in contact with the static contacts (i.e., changing the direction of the original magnetic field), especially at a center of the leading-out terminals (i.e., the arc starting point) can be enhanced, and the arc extinguishing speed by magnetic blowing at a moment of starting arc can be accelerated.

### The Second Embodiment

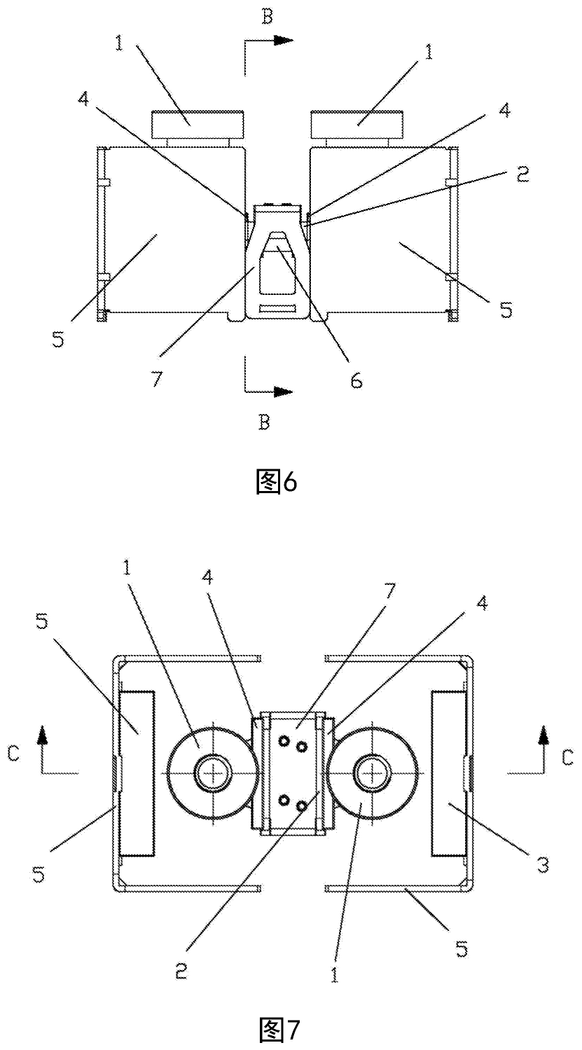

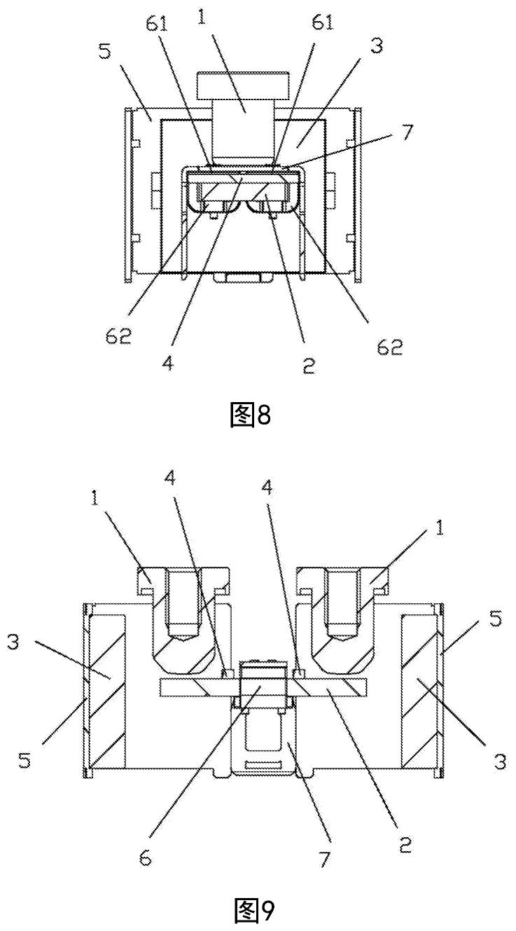

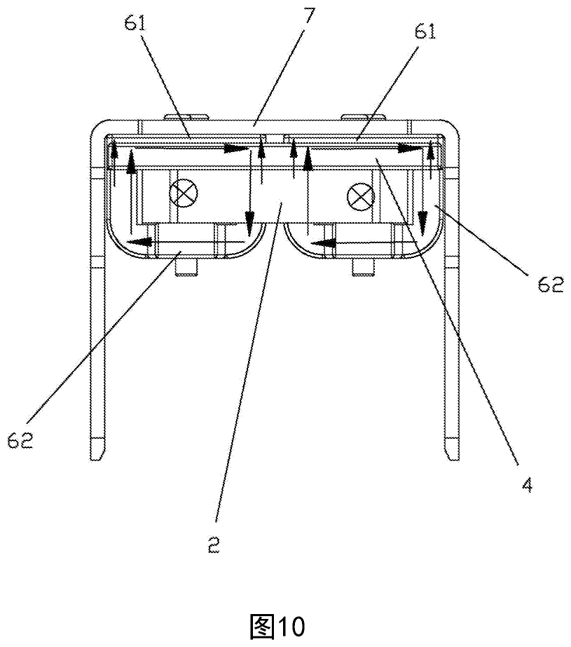

Referring to FIGS. 5 to 10, a high-voltage DC relay for enhancing arc extinguishing capability disclosed in this embodiment is different from that in the first embodiment in that an anti-short circuit structure is arranged in a middle portion of the movable contact piece 2 in a length direction, and the anti-short circuit structure is in a preset space between two second permanent magnets 4.

In this embodiment, the anti-short-circuit structure is an anti-short circuit ring 6. The anti-short circuit ring 6 is formed by the cooperation of two linear shape upper armatures 61 and two U-shaped lower armatures 62. A through hole penetrating through a thickness of the movable contact piece 2 is arranged in the middle portion of the movable contact piece 2 in a longitudinal direction. The two linear shape upper armatures 61 are usually fixed on a top of the U-shaped bracket 7 of a pushing rod of the relay by riveting or welding, and two U-shaped lower armatures 62 are respectively fixed to the movable contact piece 2 by riveting, and side walls of the two U-shaped lower armatures 62 pass through the through hole of the movable contact piece 2, and top ends of the two U-shaped lower armatures 62 are exposed out of an upper surface of the movable contact piece, to be cooperated with the two linear shape upper armatures 61. A closed magnetic circuit is formed in an annular piece formed by the linear shape upper armature 61 and the U-shaped lower armature 62 by using an annular magnetic field generated by the movable contact piece, and a suction force is generated to act on the movable contact piece 2, so as to achieve a purpose of resisting the electro-dynamic repulsion force. The anti-short circuit ring 6 of this embodiment has two magnetic circuits, so that the magnetic circuit is not easily saturated, the more the pressure of the contacts increases, the more the suction force of the magnetic circuits generates.

In this embodiment, there is a second permanent magnet 4 next to the anti-short circuit ring 6, as shown in FIG. 10, the second permanent magnet 4 has two sides acting on the magnetic field, on the one hand, the suction force of the anti-short circuit ring 6 (embodied on the left sides of the two anti-short circuit rings 6 in FIG. 10) can be enhanced; on the other hand, the repulsion force of the second permanent magnet 4 can weaken the suction force of the anti-short circuit ring 6 (embodied on the right sides of the two anti-short circuit rings 6 in FIG. 10).

In the high-voltage DC relay for enhancing arc extinguishing capability of the present disclosure, an anti-short circuit structure, i.e., the anti-short circuit ring 6, is also arranged in the middle portion of the movable contact piece 2 in a length direction. The anti-short ring 6 is in a preset space between the two second permanent magnets 4. In this structure as disclosed in the present disclosure, a small permanent magnet 4 (i.e., the second permanent magnet) is inserted between the anti-short circuit structure 6 and two large permanent magnets 3 (i.e. the first permanent magnets). If there is no small permanent magnet, the magnetic field of the large permanent magnet will affect the anti-short circuit effect of the anti-short circuit structure, but if there is the small permanent magnet, the small permanent magnet has a magnetic suction effect on the magnetic field of the large permanent magnet, so as to prevent the magnetic field of the large permanent magnet from influencing the anti-short circuit structure.

It should be understood that the application of the present disclosure is not limit to the detailed structure and arrangement of components provided in this specification. The present disclosure can have other embodiments, and can be implemented and carried out in various ways. The aforementioned variations and modifications fall within the scope of the present disclosure. It should be understood that the disclosure disclosed and defined in this specification may extend to all alternative combinations of two or more individual features that are apparent or mentioned in the text and/or drawings. All of the different combinations form various alternative aspects of the present disclosure. Embodiments described in this specification illustrate the best modes known for carrying out the present disclosure, and will allow those skilled in the art to utilize the present disclosure.

1. A high-voltage DC relay for enhancing arc extinguishing capability, comprising:
two static contact leading-out terminals;
a movable contact piece arranged under the two static contact leading-out terminals, and two ends of the movable contact piece used as movable contacts being respectively matched with bottom ends of the two static contact leading-out terminals used as static contacts;
two first permanent magnets respectively arranged at outer side of two ends of the movable contact piece in a length direction, corresponding to a position where the movable contacts are in contact with the static contacts, and sides having polarity of the two first permanent magnets respectively facing corresponding positions where the movable contacts are in contact with the static contacts;
two second permanent magnets respectively arranged on the movable contact piece between the two static contact leading-out terminals at positions where the movable contacts are in contact with the static contacts, and sides having polarity of the second permanent magnets facing the corresponding first permanent magnets, and polarities of the sides having polarity of the second permanent magnets is opposite to polarities of the sides of the first permanent magnets facing the positions where the movable contacts are in contact with the static contacts.

2. The high-voltage DC relay for enhancing arc extinguishing capability according to claim 1, wherein magnetic pole surfaces of the second permanent magnets are smaller than magnetic pole surfaces of the first permanent magnets.

3. The high-voltage DC relay for enhancing arc extinguishing capability according to claim 2, wherein the movable contact piece is in a middle portion of each of the first permanent magnets in a height direction.

4. The high-voltage DC relay for enhancing arc extinguishing capability according to claim 1, wherein the two second permanent magnets are symmetrically arranged on two sides of a center line of the movable contact piece in a length direction.

5. The high-voltage DC relay for enhancing arc extinguishing capability according to claim 4, wherein the second permanent magnets are stuck and fixed on an upper surface or a lower surface of the movable contact piece.

6. The high-voltage DC relay for enhancing arc extinguishing capability according to claim 4, wherein grooves recessed downward are formed on an upper surface of the movable contact piece, or grooves recessed upward are formed on a lower surface of the movable contact piece, and at least a portion of the second permanent magnets are embedded into the grooves.

7. The high-voltage DC relay for enhancing arc extinguishing capability according to claim 4, wherein the two second permanent magnets are two separate parts, and there is a preset space between the two second permanent magnets.

8. The high-voltage DC relay for enhancing arc extinguishing capability according to claim 4, wherein the two second permanent magnets are connected into one piece.

9. The high-voltage DC relay for enhancing arc extinguishing capability according to claim 1, wherein the high-voltage DC relay further comprises two first U-shaped yokes respectively arranged on the two first permanent magnets, a bottom wall of each first U-shaped yoke is contacted with one side of the corresponding first permanent magnet facing away from the corresponding movable contact, and two side walls of each first U-shaped yoke are respectively arranged on two sides of the movable contact piece in a width direction and are opposite to the corresponding movable contact.

10. The high-voltage DC relay for enhancing arc extinguishing capability according to claim 7, wherein an anti-short circuit structure is provided in a middle portion of the movable contact piece in a length direction; the anti-short circuit structure is arranged in the preset space between two second permanent magnets.

11. The high-voltage DC relay for enhancing arc extinguishing capability according to claim 10, wherein the anti-short circuit structure is an anti-short circuit ring.

12. The high-voltage DC relay for enhancing arc extinguishing capability according to claim 11, wherein the anti-short circuit ring is formed by matching two linear shape upper armatures and two U-shaped lower armatures; a through hole penetrating through a thickness of the movable contact piece is arranged in the middle portion of the movable contact piece in the length direction; the two upper armatures are fixed on a top portion of a U-shaped bracket of a pushing rod of the high-voltage DC relay, the two U-shaped lower armatures are respectively fixed to the movable contact piece, and side walls of the two U-shaped lower armatures pass through the through hole of the movable contact piece, top ends of the two U-shaped lower armatures are exposed out of an upper surface of the movable contact piece and correspondingly matched with the two linear shape upper armatures; a circular magnetic field generated by the movable contact piece being energized forms a closed magnetic circuit within an annular component formed by the linear shape upper armature and the U-shaped lower armature.

13. The high-voltage DC relay for enhancing arc extinguishing capability according to claim 2, wherein the two second permanent magnets are symmetrically arranged on two sides of a center line of the movable contact piece in a length direction.

14. The high-voltage DC relay for enhancing arc extinguishing capability according to claim 3, wherein the two second permanent magnets are symmetrically arranged on two sides of a center line of the movable contact piece in a length direction.
